(19) United States
(12) Patent Application Publication
(10) Pub. No.: US 2014/0168058 A1
(43) Pub. Date: Jun. 19, 2014

(54) APPARATUS AND METHOD FOR RECOGNIZING INSTRUCTION USING VOICE AND GESTURE

(71) Applicant: Hyundai Motor Company, Seoul (KR)

(72) Inventors: Dong Pil Heo, Seoul (KR); Suk Young Rho, Anyang (KR); Jae Woo Park, Anyang (KR); Jung Hoon Oh, Yongin (KR)

(21) Appl. No.: 13/933,485

(22) Filed: Jul. 2, 2013

(30) Foreign Application Priority Data
Dec. 18, 2012 (KR) 10-2012-0156614

(51) Int. Cl. G06F 3/01

(52) U.S. Cl. CPC G06F 3/017
USPC 345/156

(57) ABSTRACT

An apparatus and method that recognizes an instruction using voice and gesture to decrease time spent recognizing a sound model and a language model by recognizing the initial sound of each syllable of instructions using a gesture recognition technology and recognizing the voice for the instruction based on the recognized initial sound of each syllable.

### CROSS-REFERENCE TO RELATED APPLICATION

This application is based on and claims priority from Korean Patent Application No. 10-2012-0156614, filed on Dec. 28, 2012 in the Korean Intellectual Property Office, the disclosure of which is incorporated herein in its entirety by reference.

### BACKGROUND OF THE INVENTION

1. Field of the Invention

The present invention relates to an apparatus and a method that recognizes an instruction using voice and gesture, and more particularly, to a technology that decreases time spent recognizing a sound model and a language model by recognizing the initial sound of each syllable of instructions using a gesture recognition technology and recognizing the voice for the instruction based on the recognized initial sound of each syllable.

2. Description of the Prior Art

In accordance with development of a multimedia technology and development of an interface, research has been conducted on recognition technology of a multimodal form using a facial expression or direction, a lip shape, a gaze tracking, a hand gesture, voice, and the like to easily and simply implement an interface between a person and a machine.

Particularly, a voice recognition technology and a gesture recognition technology among the present man-machine interface technologies have emerged as the most convenient technologies. However, the voice recognition technology and the gesture recognition technology show high recognition rate in a restricted environment, that does not extend to a substantially high noise environment since environmental noise has the greatest effect on a performance of the voice recognition and the gesture recognition technology based on an imaging device (e.g., a camera) change according to light change and a gesture type.

Therefore, the voice recognition technology needs a development of a technology that recognizes the voice using an algorithm resistant to noise, and the gesture recognition technology needs a development of a technology that extracts a specific interval of the gesture including recognition information. In addition, when the recognition is performed by blending the voice and the gesture in parallel, processing time and throughput of a processor (CPU) increase since two features must be processed.

### SUMMARY

Accordingly, the present invention provides an apparatus and method that recognizes an instruction using voice and gesture and decreases time spent recognizing a sound model and a language model by recognizing the initial sound of each syllable of instructions using a gesture recognition technology and recognizing the voice for the instruction based on the recognized initial sound of each syllable.

In one aspect of the present invention, an apparatus that recognizes an instruction using voice and gesture may include a plurality of units executed by a controller having a processor and a storage device. The plurality of units may include: a gesture inputting unit configured to receive a captured gesture of a user; a gesture recognizing unit configured to recognize an initial sound corresponding to the gesture received through the gesture inputting unit; a voice inputting unit configured to receive a voice instruction from the user; a candidate instruction determining unit configured to analyze the voice instruction received through the voice inputting unit and determine a candidate instruction; a similarity calculating unit configured to compare the initial sound recognized by the gesture recognizing unit with the candidate instruction determined by the candidate instruction determining unit and calculate a similarity therebetween; and an instruction recognizing unit configured to determine the candidate instruction having a greatest similarity calculated by the similarity calculating unit as a final instruction.

In another aspect of the present invention, a method that recognizes an instruction using voice and gesture may include: receiving, by a controller, a captured gesture of a user; recognizing, by the controller, an initial sound corresponding to the captured gesture; receiving, by the controller, a voice instruction from the user; analyzing, by the controller, the received voice instruction to determine a candidate instruction; comparing, by the controller, the recognized initial sound with the determined candidate instruction to calculate a similarity therebetween; and determining, by the controller, the candidate having the greatest calculated similarity as a final instruction.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary view of an apparatus that recognizes an instruction using voice and gesture according to an exemplary embodiment of the present invention; and

FIG. 2 is an exemplary flow chart of a method that recognizes an instruction using voice and gesture according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, an embodiment of the present invention will be described in detail with reference to the accompanying drawings.

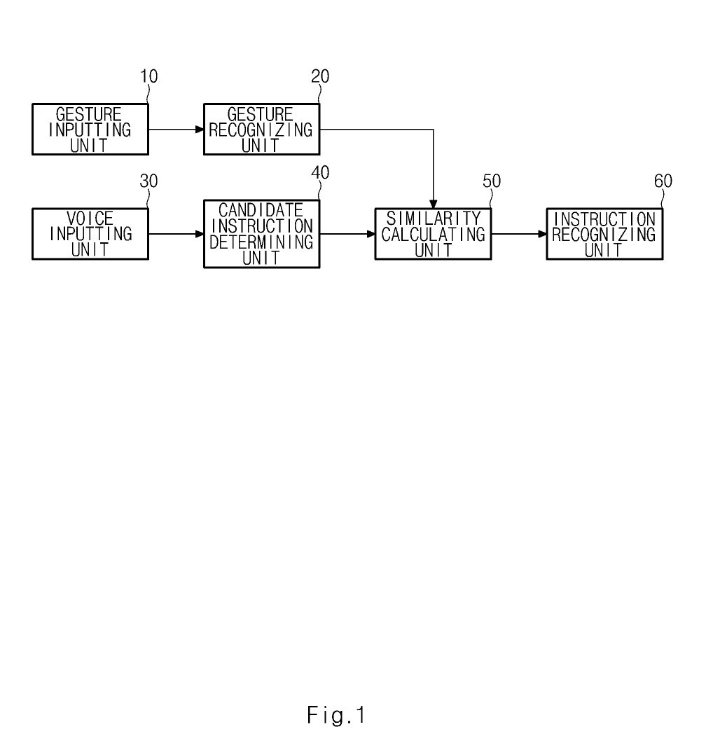

FIG. 1 is an exemplary view of an apparatus that recognizes an instruction using voice and gesture according to an exemplary embodiment of the present invention. As shown in FIG. 1, the apparatus that recognizes an instruction using the voice and the gesture may include a plurality of units executed by a controller having a processor and a storage device. The plurality of units may include a gesture inputting unit 10, a gesture recognizing unit 20, a voice inputting unit 30, a candidate instruction determining unit 40, a similarity calculating unit 50, and an instruction recognizing unit 60.

The above-mentioned respective components will be described. First, the gesture inputting unit 10, which may be a type of imaging device (e.g., a camera), may be configured to receive a gesture of a user. In particular, the gesture input from the user may be a gesture having a simple form to lower complexity needed when recognizing the gesture. In other words, the gesture may be for example different consonants. Initial sounds of a letter input as described above simplify processes of recognizing a voice instruction, thereby making it possible to recognize the voice instruction having low complexity in a short period of time.

The gesture recognizing unit 20 may be configured to recognize the gesture received through the gesture inputting unit 10 and output initial sound information corresponding to the gesture. In other words, the gesture recognizing unit 20 may be configured to recognize the initial sound (e.g., a consonant) corresponding to the gesture received through the gesture inputting unit 10.

The gesture recognizing unit 20 as described above may include a gesture initial sound database that recognizes characteristics of the gesture input through the gesture inputting unit 10 and detects an initial sound corresponding to the gesture. The gesture initial sound database may store a number of simple gestures.

Furthermore, the voice inputting unit 30, may be a type of microphone and may be configured to receive a voice instruction from the user. The candidate instruction determining unit 40 may be configured to analyze the voice instruction received through the voice inputting unit 30 and determine a candidate instruction. The candidate instruction determining unit 40 may be configured to select the candidate instruction based on sound model and language model as the known technology.

Moreover, the similarity calculating unit 50 may be configured to compare the initial information recognized by the gesture recognizing unit 20 with the candidate instruction determined by the candidate instruction determining unit 40 and calculate a similarity therebetween. In other words, the similarity calculating unit 50 may be configured to calculate a degree that the initial information recognized by the gesture recognizing unit 20 is included in the candidate instruction. Additionally, the similarity calculating unit 50 may be configured to calculate the similarity using the voice recognition technology in addition to the initial sound information.

Furthermore, the instruction recognizing unit 60 may be configured to determine the candidate instruction having the greatest similarity calculated by the similarity calculating unit 50 as a final instruction.

A voice recognizing ratio may be increased by coupling the gesture recognition technology and the voice recognition technology as described above, as opposed to separately blending the gesture recognition technology and the voice recognition technology as in the related art. Meanwhile, the present invention may be mounted on an audio, video, and navigation (AVN) system of a vehicle to recognize a variety of instructions from a driver. For example, the instruction may be an instruction required to control the AVN system.

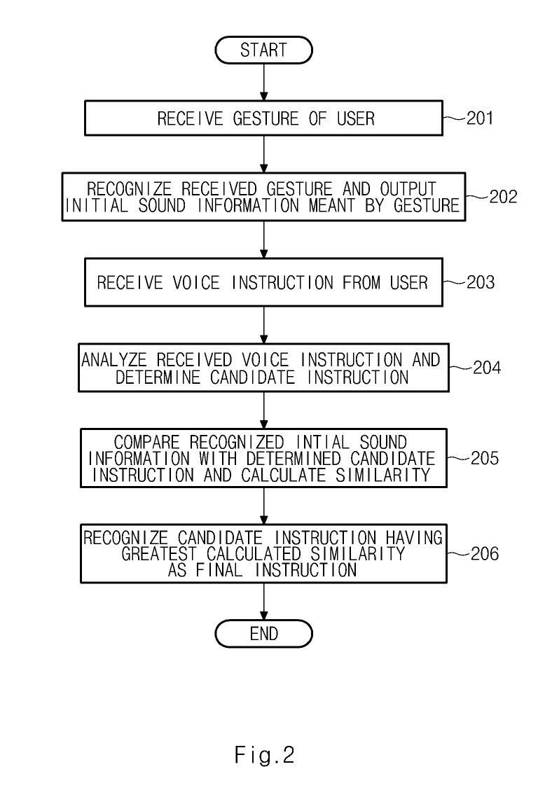

FIG. 2 is an exemplary flow chart of a method that recognizes an instruction using voice and gesture according to an exemplary embodiment of the present invention. The method may include: receiving, by a controller, a captured gesture of a user (201); recognizing, by the controller, the captured gesture and outputting the initial sound information corresponding to the captured gesture (202); receiving, by the controller, the voice instruction from the user (203); analyzing, by the controller, the received voice instruction and determining the candidate instruction (204); comparing, by the controller, the recognized initial information with the determined candidate instruction and calculating the similarity therebetween (205); and recognizing, by the controller, the candidate instruction having the greatest calculated similarity as a final instruction (206).

In the present invention, the process of inputting the gesture and the process of inputting the voice instruction may be simultaneously performed and any one of the processes may be first performed. Thus, the order of processes has no effect on the present invention.

The present invention may decrease time spent recognizing a sound model and a language to model by recognizing the initial sound of each syllable of instructions using a gesture recognition technique and recognizing the voice for the instruction based on the recognized initial sound of each syllable. In other words, the present invention may decrease voice recognition error and improve a processing speed by recognizing the initial sound of each syllable of the instruction using the gesture recognition technique and recognizing the voice for the instruction based on the recognized initial sound of each syllable.

What is claimed is:

1. An apparatus that recognizes an instruction using voice and gesture, the apparatus comprising:
a controller configured to:
receive a captured gesture of a user;
recognize an initial sound corresponding to the captured gesture;
receive a voice instruction from the user;
analyze the received voice instruction and determine a candidate instruction;
compare the recognized initial sound with the determined candidate instruction and calculate a similarity therebetween; and
determine the candidate instruction having a greatest similarity as a final instruction.

2. The apparatus according to claim 1, wherein the controller includes a gesture initial sound database from which the initial sound may be determined corresponding to the captured gesture.

3. The apparatus according to claim 1, where in the captured gesture may be at least one consonant.

4. The apparatus according to claim 1, wherein the apparatus is applied to an audio, video, and navigation (AVN) system of a vehicle.

5. A method that recognizes an instruction using voice and gesture, the method comprising:
receiving, by a controller, a captured gesture of a user;
recognizing, by the controller, an initial sound corresponding to the captured gesture;
receiving, by the controller, a voice instruction from the user;
analyzing, by the controller, the received voice instruction to determine a candidate instruction;
comparing, by the controller, the recognized initial sound with the determined candidate instruction to calculate a similarity therebetween; and
determining, by the controller, the candidate having a greatest calculated similarity as a final instruction.

6. The method according to claim 5, wherein in the recognizing of the initial sound, the initial sound corresponding to the captured gesture is recognized based on a gesture initial sound database.

7. The method according to claim 5, wherein the captured gesture may be at least one consonant.

8. A non-transitory computer readable medium containing program instructions executed by a controller, the computer readable medium comprising:
program instructions that receive a captured gesture of a user;
program instructions that recognize an initial sound corresponding to the captured gesture;
program instructions that receive a voice instruction from the user;
program instructions that analyze the received voice instruction to determine a candidate instruction;
program instructions that compare the recognized initial sound with the determined candidate instruction to calculate a similarity therebetween; and
program instructions that determine the candidate having a greatest calculated similarity as a final instruction.

9. The non-transitory computer readable medium of claim 8, wherein the program instructions recognize the initial sound corresponding to the captured gesture based on a gesture initial sound database.

10. The non-transitory computer readable medium of claim 8, wherein the captured gesture may be at least one consonant.
